(19) United States
(12) Patent Application Publication
(10) Pub. No.: US 2011/0164546 A1
(43) Pub. Date: Jul. 7, 2011

(54) VEHICULAR MOBILITY VECTOR BASED ROUTING

(76) Inventors: Rajesh K. Mishra, Westford, MA (US); Jeffrey E. Smith, Nashua, NH (US); Peter Atwal, Longwood, FL (US)

(21) Appl. No.: 13/062,072

(22) PCT Filed: Sep. 4, 2009
(86) PCT No.: PCT/US2009/056134

§ 371 Date: Mar. 3, 2011

Related U.S. Application Data
(60) Provisional application No. 61/094,394, filed on Sep. 4, 2008.
(60) Provisional application No. 61/094,594, filed on Sep. 5, 2008.
(60) Provisional application No. 61/094,584, filed on Sep. 5, 2008.
(60) Provisional application No. 61/094,546, filed on Sep. 5, 2008.
(60) Provisional application No. 61/094,611, filed on Sep. 5, 2008.
(60) Provisional application No. 61/094,591, filed on Sep. 5, 2008.
(60) Provisional application No. 61/095,298, filed on Sep. 8, 2008.
(60) Provisional application No. 61/095,310, filed on Sep. 9, 2008.
(60) Provisional application No. 61/103,106, filed on Oct. 6, 2008.
(60) Provisional application No. 61/112,131, filed on Nov. 6, 2008.
(60) Provisional application No. 61/118,232, filed on Nov. 26, 2008.
(60) Provisional application No. 61/121,169, filed on Dec. 9, 2008.

(30) Foreign Application Priority Data
Apr. 3, 2009 (US) 12418363

(51) Int. Cl. H04H 20/71

(52) U.S. Cl. 370/312

(57) ABSTRACT

Enhancements are disclosed to improve communications within a wireless ad hoc network for mobile nodes. Mobile nodes may move at a speed where benefit may be seen from anticipating where the node will be in the future. Routing is described which estimates the location where the next communication will take place and packets are sent to one or more corresponding locations. Various other described techniques provide for enhanced wireless communications.

### RELATED APPLICATIONS

This application is a national stage filing under U.S.C. §371 of published International Application No. PCT/US09/56134 filed on Sep. 4, 2009, which is incorporated herein by reference in its entirety. International application PCT/US09/56134 was published in English as Publication No. WO 2010/028315.

International Application No. PCT/US09/56134 claims priority to the following U.S. Provisional Patent Applications: U.S. App. No. 61/094,394 filed Sep. 4, 2008; U.S. App. No. 61/094,546 filed Sep. 5, 2008; U.S. App. No. 61/118,232 filed Nov. 26, 2008; U.S. App. No. 61/094,584 filed Sep. 5, 2008; U.S. App. No. 61/094,591 filed Sep. 5, 2008; U.S. App. No. 61/094,594 filed Sep. 5, 2008; U.S. App. No. 61/094,611 filed Sep. 5, 2008; U.S. App. No. 61/095,298 filed Sep. 8, 2008; U.S. App. No. 61/095,310 filed Sep. 9, 2008; U.S. App. No. 61/103,106 filed Oct. 6, 2008; U.S. App. No. 61/111,384 filed Nov. 5, 2008; U.S. App. No. 61/112,131 filed Nov. 6, 2008; and U.S. App. No. 61/121,169 filed Dec. 9, 2008.

International Application No. PCT/US09/56134 also claims priority to U.S. application Ser. No. 12/418,363 filed on Apr. 3, 2009 which claim the benefit of the following applications: U.S. Provisional App. No. 61/042,431 filed Apr. 4, 2008; U.S. Provisional App. No. 61/042,442 filed Apr. 4, 2008; U.S. Provisional App. No. 61/074,930 filed Jun. 23, 2008; U.S. Provisional App. No. 61/082,618 filed Jul. 22, 2008; U.S. Provisional App. No. 61/082,642 filed Jul. 22, 2008; U.S. Provisional App. No. 61/086,242 filed Aug. 5, 2008; U.S. Provisional App. No. 61/084,738 filed Jul. 30, 2008; U.S. Provisional App. No. 61/084,773 filed Jul. 30, 2008; U.S. Provisional App. No. 61/094,394 filed Sep. 4, 2008; U.S. Provisional App. No. 61/094,546 filed Sep. 5, 2008; U.S. Provisional App. No. 61/118,232 filed Nov. 25, 2008; U.S. Provisional App. No. 61/094,584 filed Sep. 5, 2008; U.S. Provisional App. No. 61/094,591 filed Sep. 5, 2008; U.S. Provisional App. No. 61/094,594 filed Sep. 5, 2008; U.S. Provisional App. No. 61/094,611 filed Sep. 5, 2008; U.S. Provisional App. No. 61/095,298 filed Sep. 8, 2008; U.S. Provisional App. No. 61/095,310 filed Sep. 9, 2008; U.S. Provisional App. No. 61/094,183 filed Sep. 4, 2008; U.S. Provisional App. No. 61/094,203 filed Sep. 4, 2008; U.S. Provisional App. No. 61/094,279 filed Sep. 4, 2008; U.S. Provisional App. No. 61/094,294 filed Sep. 4, 2008; U.S. Provisional App. No. 61/094,231 filed Sep. 4, 2008; U.S. Provisional App. No. 61/094,247 filed Sep. 4, 2008; U.S. Provisional App. No. 61/094,310 filed Sep. 4, 2008; U.S. Provisional App. No. 61/103,106 filed Oct. 6, 2008; U.S. Provisional App. No. 61/111,384 filed Nov. 5, 2008; U.S. Provisional App. No. 61/112,131 filed Nov. 6, 2008; and U.S. Provisional App. No. 61/121,169 filed Dec. 9, 2008.

Each of the foregoing applications is incorporated herein by reference in its entirety.

### FIELD OF INVENTION

This application relates generally to networking and more particularly to wireless networking with a node in motion.

### BACKGROUND

Networking and communications is a vastly complex field which includes a multitude of wireless communication techniques, especially when considering mobile nodes. Nodes and links exist as part of a wireless network. Nodes can be in the form of access points, backhaul access points, subscriber devices, mobile nodes, and other points of communication. Links are the connection over which various forms of data may be communicated. The links are between the various nodes which form the wireless network. Most wireless communications today have a cell-based infrastructure where nodes communicate with base stations. As an alternative, wireless communications can be performed by an ad hoc network where the various nodes can communicate with each other and a wireless network can morph as mobile nodes come into and out of proximity of one another and various fixed nodes.

By their nature, these wireless networks are distributed. Modifications to the networks may be accomplished by cumbersome techniques which may slow communications or may limit the quality of communications. The network modifications require key communications with mobile nodes typically requiring more communications to support the modifications. The modifications often involve changes in routing paths for the data being communicated. When mobile nodes travel at a faster speed than the wireless ad hoc network can converge on a routing solution, mobile nodes may miss data when the data is routed through nodes or access points where the mobile nodes can no longer be reached. There therefore remains a need for enhanced wireless communications in support of mobile nodes.

### SUMMARY

Enhancements are disclosed for wireless ad hoc networking with highly mobile nodes. Various methods, techniques, apparatus and the like are described to facilitate wireless ad hoc network communications. In embodiments, a method for wireless communication on a wireless ad hoc network may comprise identifying a node within the wireless ad hoc network where the node is a mobile node and the node is moving above a certain rate of speed; determining a motion vector for the node; calculating route prediction estimates based on location data and the motion vector for the node; and performing scoped multicasting to transmit data to locations where the node is expected to be based on the route prediction estimates. The calculating route prediction estimates may include estimating that the node will move to a different backhaul access point domain based on the motion vector. Some embodiments may further compare transmitting to the different backhaul access point domain. The node may be restricted from relaying data as part of the scoped multicasting. The node may preferentially communicate with a specific backhaul access point. In some embodiments, the method may further comprise communicating between the node and a second mobile node with a similar motion vector. Communicating may include relaying the data through the second mobile node. The motion vector may be determined using global positioning system (GPS) techniques. The data may be transmitted to multiple location nodes based on the motion vector. The data at one of the multiple location nodes may be discarded since the one of the multiple location nodes is found to not be a one hop neighbor of the node.

In some embodiments, a computer readable medium bearing instructions for wireless communication that, when executed, cause a wireless ad hoc network to may perform the steps of: identifying a node within the wireless ad hoc network where the node is a mobile node and the node is moving above a certain rate of speed; determining a motion vector for the node; calculating route prediction estimates based on location data and the motion vector for the node; and performing scoped multicasting to transmit data to locations where the node is expected to be based on the route prediction estimates. In embodiments, the computer readable medium may further performs the step of transmitting to the different backhaul access point domain. In embodiments, the computer readable medium may further performs the step of communicating between the node and a second mobile node with a similar motion vector.

Various features, aspects, and advantages of various embodiments will become more apparent from the following further description.

### BRIEF DESCRIPTION OF THE DRAWINGS

The invention and the following detailed description of certain embodiments thereof may be understood by reference to the following figures wherein:

FIG. 1 is a block diagram of a Mobile Ad Hoc Network (MANET).

FIG. 2 shows a MANET Wireless Protocol that may be used by devices within a MANET.

FIG. 3 is a block diagram of a node in a wireless ad hoc network.

FIG. 4 shows vehicular mobility traffic.

FIG. 5 shows a flowchart for a method of transmitting to anticipated locations.

FIG. 6 shows a MANET containing two MANET BAP domains.

FIG. 7 illustrates information maintained by nodes in a MANET protocol.

### DETAILED DESCRIPTION

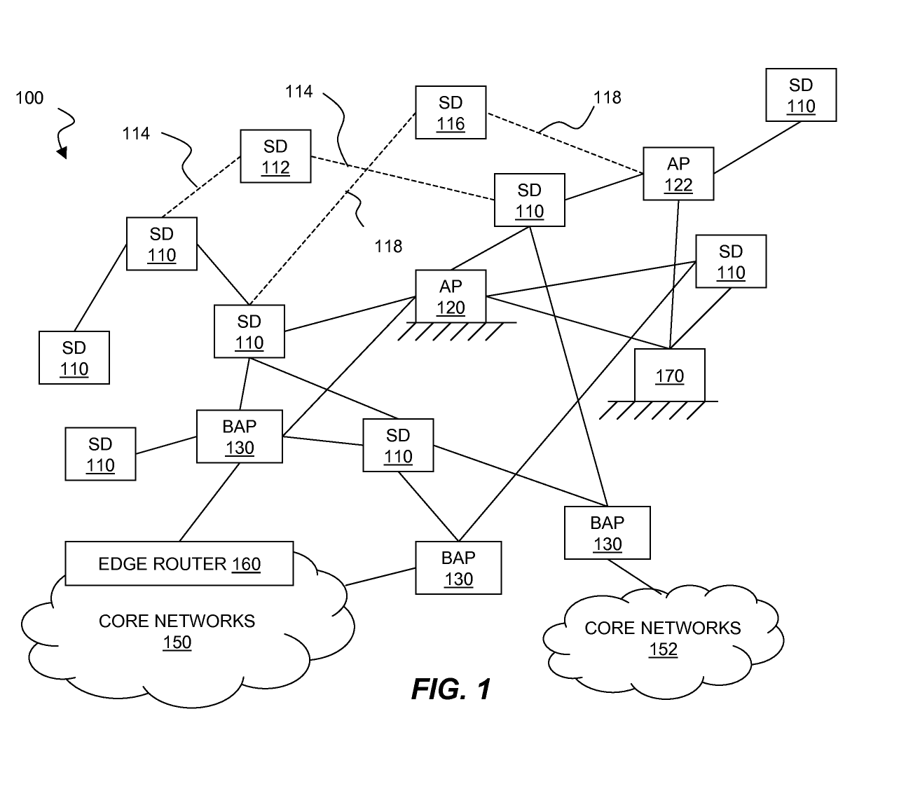

The present disclosure provides a description of various methods, apparatus, and techniques which facilitate wireless communication in wireless ad hoc networks especially focusing on those which aid mobile nodes. FIG. 1 shows a Mobile Ad Hoc Network (MANET) that may be used with the systems and methods described herein. In general, a MANET 100 (also referred to generally herein as a network 100) may include subscriber devices 110, access points 120, and backhaul access points 130 (for coupling to a core network 150 such as the Internet), all generally interconnected to one another as shown for example in FIG. 1. Without limiting the generality of the foregoing, one or more of the subscriber devices 110 may be a stationary device 170 that does not geographically move within the MANET 100. It will be understood that the device-to-device links illustrated in FIG. 1 are for purposes of illustration only, and in no way are intended to limit the nature or number of links between devices in the MANET 100, which may be created, removed, and/or modified over time according to any corresponding protocols followed by the devices within the MANET 100. In general, the links among devices or components within the MANET 100 are wireless links, although wired links may optionally be employed in various locations such as between the backhaul access point 130 and the core networks 150. In order to maintain the MANET 100, typically one or more protocols are shared among the participating devices to control creation, removal, and modification of individual data links between devices, and to route traffic and control information among the devices. The term protocol as used herein generally refers to any and all such rules, procedures, and/or algorithms used in maintaining the MANET 100, unless a specific protocol is explicitly stated or otherwise clear from the context.

Subscriber devices 110 may include any general purpose nodes participating in the MANET 100 according to suitable protocols. Subscriber devices 110 may, for example, include terminal nodes that send or receive data. Subscriber devices 110 may also or instead suitably be employed as intermediate nodes to route traffic to and from other subscriber devices 110. Thus an ad hoc network as described herein is generally extensible, and as new subscriber devices 110 appear within the MANET 100, they may form a part of the MANET 100 fabric that routes traffic among other nodes. A new subscriber device 112 may be introduced to the MANET 100 with new links 114 being added as the new subscriber device 112 is detected. Devices may also periodically leave the MANET 100 such as a departing subscriber device 116. As the departing subscriber device 116 leaves the network, links 118 between the departing subscriber device 116 and other subscriber devices 110, access points 122, stationary devices 170, backhaul access points 130, and/or other devices may be severed. This may occur, for example when a device moves beyond geographical boundaries of the MANET 100, when devices in the MANET are turned off (or their wireless or networking capabilities are suspended), or when a hardware or software malfunction occurs. The MANET 100 may in a centralized or distributed manner detect new and/or departing devices and/or links in order to maintain substantially continuous connectivity for devices in the MANET 100.

In general, a subscriber device 110 may include any network or computing device that includes a wireless interface, network protocol stack(s), and the like adapted to participate in the MANET 100. The Internet Protocol may usefully be employed in subscriber devices 110 within the MANET 100 in order to use well-established addressing schemes and the like. A subscriber device 110 may include without limitation a cellular phone, personal digital assistant, wireless electronic mail client, laptop computer, palmtop computer, desktop computer, video device, digital camera, electrical instrument, sensor, detector, display, media player, navigation device, smart phone, wireless networking card, wireless router (e.g., for a local WiFi network), storage device, printer, or any other device that might usefully participate in a network. In some embodiments subscriber devices may include a GPS receiver providing a position and timing reference. In embodiments, each subscriber device 110 may be authenticated and/or authorized before being granted access to the MANET 100.

Access points 120 may be provided to establish a permanent or otherwise generally stable infrastructure to the MANET 100. An access point 120 may be fixed in location or may be limited in the amount that it can move. One or more of the access points 120 may be mobile access points 122 that can freely move within the MANET 100. The access points 120 may employ identical network functionality and protocol stacks as the subscriber devices 110 described above. The access points 120 may also or instead encapsulate different functionality consistent with a more specialized role in the MANET 100. In one aspect, the access points 120 may have no associated computing device that originates or consumes network traffic. That is, the access points 120 may simply form a mesh of participants in the MANET 100 and relay traffic among other network participants. An access point 120 may also include a physical connection to a power infrastructure so that it may be physically installed at a location and operate autonomously without requiring regular maintenance for battery changes and the like. In another aspect, access points 120 may include some minimal supplemental circuitry related to, e.g., status and diagnostics, or for receiving software updates and the like. By arranging a spanning network of access points 120 network continuity may be improved in areas where subscriber devices 110 are not present or are not expected to be present with any regularity. In embodiments an access point 120 may be of a size and weight making it suitable for mounting and/or concealment in a variety of locations including indoor and outdoor locations, and including mounting on walls, floors, ground, ceilings, roofs, utility poles, and so forth.

Each access point 120 may include or utilize a timing reference such as any of the Network Timing Protocols described in RFC 778, RFC 891, RFC 956, RFC 958, RFC 1305, RFC 1361, RFC 1769, RFC 2030, and RFC 4330, all published by The Internet Engineering Task Force. Each access point may also, or instead, include a GPS receiver providing a position and timing reference, or any other open or proprietary timing system may be employed.

In embodiments the access points 120 may have a greater transmit power and/or a greater antenna gain than mobile subscriber devices 110, thus providing greater physical coverage than some other devices within the MANET 100.

The MANET 100 may include one or more backhaul access points 130 that generally operate to connect nodes within the MANET 100 to a core network 150 such as the Internet. A core network 150 may be a fixed network or may be an infrastructure network. On one interface, a backhaul access point 130 may have a wireless radio interface, protocol stack(s) and other components of other nodes within the MANET 100. On another interface, the backhaul access point 130 may provide any suitable interface to the core network 150. The backhaul access point 130 may, for example, be deployed at a fiber access point or the like that provides high-speed data capacity for Internet traffic or the like. For example and without limitation, the fiber access point may include a Gig-E router site or an OC-3/12 add-drop multiplexer site. In an embodiment the backhaul access point 130 may include two Gig-E interfaces for backhaul connections. It will be understood that any number and variety of suitable interfaces for backhaul connections may be usefully employed with a backhaul access point 130 as described herein.

A backhaul access point 130 may serve multiple access points 120 within the MANET 100, and may distribute network load across those access points. Alternatively, a single backhaul access point 130 may serve a single access point 120. The number of access points 120 served by a backhaul access point 130 may depend on various factors such as the amount of intra-MANET traffic and extra-MANET traffic, the nature and direction of multicast versus unicast data, and so forth. This association between backhaul access points 130 and access points 120 may change from time to time depending on the presence of other subscriber devices 110 within the area, network conditions, network traffic demands, and so forth. In some cases or under some operating conditions, an access point 120 may be associated with more than one backhaul access point 130.

An edge router 160 may be included between the core network 150 and one or more backhaul access points 130. The edge router 160 may facilitate routing between the MANET 100 and the core networks 150. The core networks 150 may be connected through an edge router 160 to a backhaul access point 130 or may be directly connected to a backhaul access point 130 without going through the edge router 160. More than one edge router 160 may be used to contact multiple backhaul access points 130. In embodiments one edge router may contact multiple backhaul access points 130. The edge router 160 may include any devices or systems for maintaining connectivity between the MANET 100 and the core networks 150, and may further support or enhance network activity within the MANET 100. For example, the edge router 160 may include an industry standard and/or proprietary Address Resolution Protocol server, an application server, a Virtual Private Network server, a Network Address Translation server, a firewall, a Domain Name System server, a Dynamic Host Configuration Protocol server, and/or an Operations, Administration, Maintenance and Provisioning server, and the like, as well as any combination of the foregoing. These various components may be integrated into the edge router 160, or may be provided as separate (physical and/or logical) systems that support operation of the edge router 160. These supporting systems may in general support operations such as broadband Internet connectivity within the MANET 100, broadcast communications crossing between the MANET 100 and the core networks 150, and so forth, as well as the use of multiple backhaul access points 130 to efficiently route inter-MANET (and/or intra-MANET) traffic among subscriber devices 110.

The core networks 150 may include any network resources outside the MANET 100. As shown in FIG. 1, there may be any number of different core networks, which may for example include a second core network 152 connected to the MANET 100 through a backhaul access point 130. The second core network 152 may be wholly independent from the core network 150, or may connect to the core network 150 through a fixed or other type of network. The core networks 150 may connect disparate, geographically remote and/or local instances of the MANET 100 to form a single network. The core networks 150 may include any and all forms of IP networks, including LANs, MANs, WANs, and so on. The core networks 150 may also or instead include the public Internet, the Public Switched Telephone Network, a cellular communications network, or any other network or combination of networks for data traffic, voice traffic, media broadcasting, and so forth. In other embodiments the core networks 150 may consist exclusively of a single zone of administrative control, or a number of zones of administrative control, or some combination of an administrative zone and any of the foregoing.

The stationary device 170 may include any subscriber device 110 that, for whatever reason, does not physically move within the MANET 100. In general, such fixed physical points within the MANET 100 may provide useful routing alternatives for traffic that can be exploited for load balancing, redundancy, and so forth. This may include, for example, a fixed desktop computer within the MANET 100.

Communication within the MANET 100 may be accomplished via protocols, referred to collectively herein as the MANET Wireless Protocol (MWP). In general, any of the nodes above that participate in the MANET 100 according to the MWP may include a hardware platform enabling radio software and firmware upgrades, which may include for example a dedicated or general purpose computing device, memory, digital signal processors, radio-frequency components, an antenna, and any other suitable hardware and/or software suitable for implementing the MWP in participating nodes.

In embodiments, any of the foregoing devices such as one of the access points 120 may also include an adapter for other networks such as an Ethernet network adapter or equivalent IP network adapter, router, and the like, so that non-MANET equipment can participate in the MANET 100 through the device. It will also be appreciated that, while connections to core networks 150, 152 are shown, this connection is optional. A MANET 100 (with or without access points 120) may be maintained independently without connections to any other networks, and may be usefully employed for the sole purpose of trafficking data among subscriber devices 110.

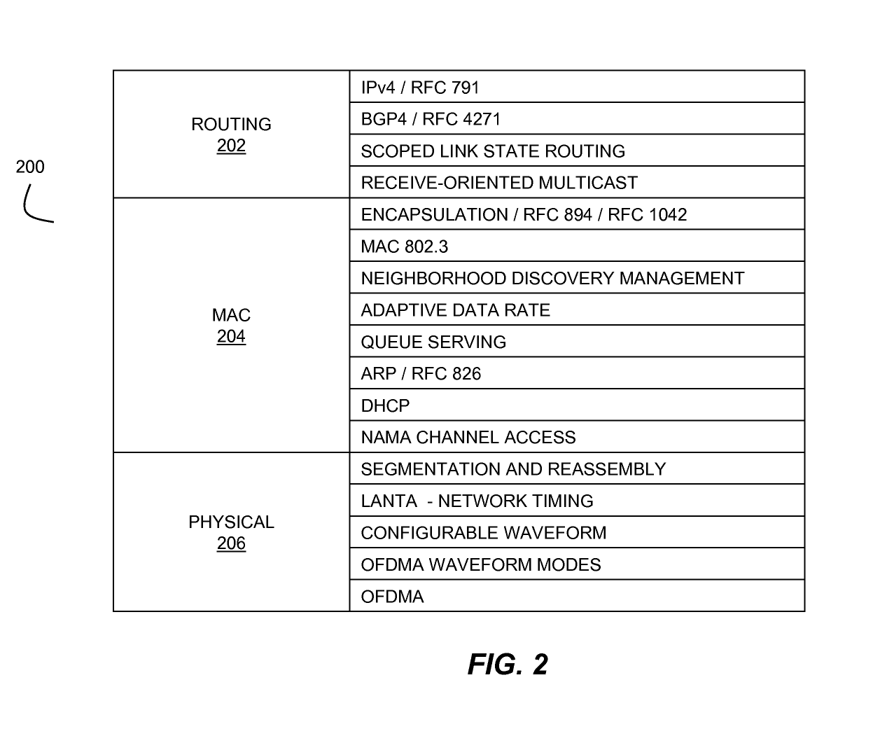

FIG. 2 shows a MANET Wireless Protocol (MWP) stack that may be used by devices within the MANET 100 of FIG. 1.

In general, a protocol stack provides a reference model for communications among network devices so that functions necessary or useful for network communications are available while each functional layer can be designed, modified, and/or deployed free from the implementation details of neighboring layers. Methods and systems disclosed herein may employ any suitable protocol stack to support wireless communications among devices. This may include, for example the Open Systems Interconnection (OSI) Reference Model (with seven layers labelled Application, Presentation, Session, Transport, Network, Data Link (LLC & MAC), and Physical) or the TCP/IP model (with four layers labelled Application, Transport, Internet, Link) along with any adaptations or variations thereof suitable for use in a MANET, or any entirely different computer network protocol design. The lower layer(s) of a protocol stack that support physical interfaces, medium access control, routing and the like may be modified to accommodate mobile wireless ad hoc networking while industry-standard protocols are supported at the routing layer (e.g., for routing at a MANET boundary and/or beyond) and above. In this manner, industry standard applications and devices may be employed within the MANET while using the MANET infrastructure to manage communication. Thus, applications designed for the fixed Internet may be deployed in the MANET, and vice versa, without requiring intervention, such as of a carrier or service provider.

In various embodiments, functions within each layer may be augmented, reduced, or modified on a device-by-device basis. For example, the functionality of each of the layers may be pruned to meet specific requirements without deviating from the scope of the invention. The function(s) of a particular layer may be implemented in software and/or hardware without deviating from the scope of the invention.

As shown in FIG. 2, the layers of a MANET Wireless Protocol (MWP) stack may include a routing layer 202, a medium access control (“MAC”) layer 204, and a physical layer 206. By way of example and not of limitation, each of these layers and the associated functions are now discussed in greater detail.

The routing layer 202 may implement industry standards for routing such as IPv4/ RFC 791 and BGP4/ RFC 4271. The routing layer 202 may also implement wireless ad hoc networking technologies to replace, e.g., OSPF/RFC 2740 such as scoped link state routing and/or receiver-oriented multicast. This layer may for example support industry-standard unicast and multicast routing protocols at a boundary between a MANET and a fixed network while providing propriety unicast and multicast routing within the MANET.

The MAC layer 204 may implement industry standards for medium access control such as RFC's 894/1042 for encapsulation, MAC 802.3, ARP/RFC 826, and DHCP. The MAC layer 204 may also implement wireless ad hoc networking technologies to replace, e.g., 802.2 LLC and 802.1q such as neighbor discovery management, adaptive data rates, and proprietary queue serving. Similarly, PPP/RFC's 1661/2516 may be substituted with proprietary link scheduling and/or node activated multiple access (NAMA) channel access. The MAC layer 204 may, for example, support quality of service differentiation using channel access and/or queue servicing to prioritize delay-sensitive traffic. In this layer, neighbor management may establish network entry for devices and track changes in each node's local one-hop and two-hop neighborhoods, such as through a message exchange with one-hop neighbors. The MAC layer 204 may support adaptive power control by adjusting transmit power on a link-by-link basis in a MANET in a manner that, e.g., maximizes transmission capacity while minimizing interference according to link conditions and topology. Adaptive data rates may be employed on a link-by-link basis to maximize transmission capacity according to individual link conditions. Queue servicing may provide buffers for data awaiting transmission through a physical layer 206 interface, and may incorporate differentiated quality of service. At the same time, channel access may be used to determine which node transmits in each TDMA time slot, with a schedule influenced by quality-of-service parameters.

The physical layer 206 may implement wireless technologies such as segmentation and reassembly of physical layer transmissions, local area node tracking algorithm (LANTA) network timing, and slot-by-slot configurable waveforms, as well as multiple waveform modes including time domain multiple access and frequency domain multiple access waveforms, or more generally any waveforms that support multiplexing or multiple access based on time, frequency, coding, or the like. In general network timing is also provided within the physical layer 206, and may correct time and frequency errors to ensure that all nodes are operating with a common timebase. At the same time, waveform mode self-discovery may be employed so that each receiver can autonomously discover which waveform mode was sent from a transmitter.

These and other functions and details of operation of a MANET Wireless Protocol stack are described in greater detail for example in U.S. application Ser. No. 12/418,363 filed on Apr. 3, 2009, the entire contents of which are incorporated herein by reference.

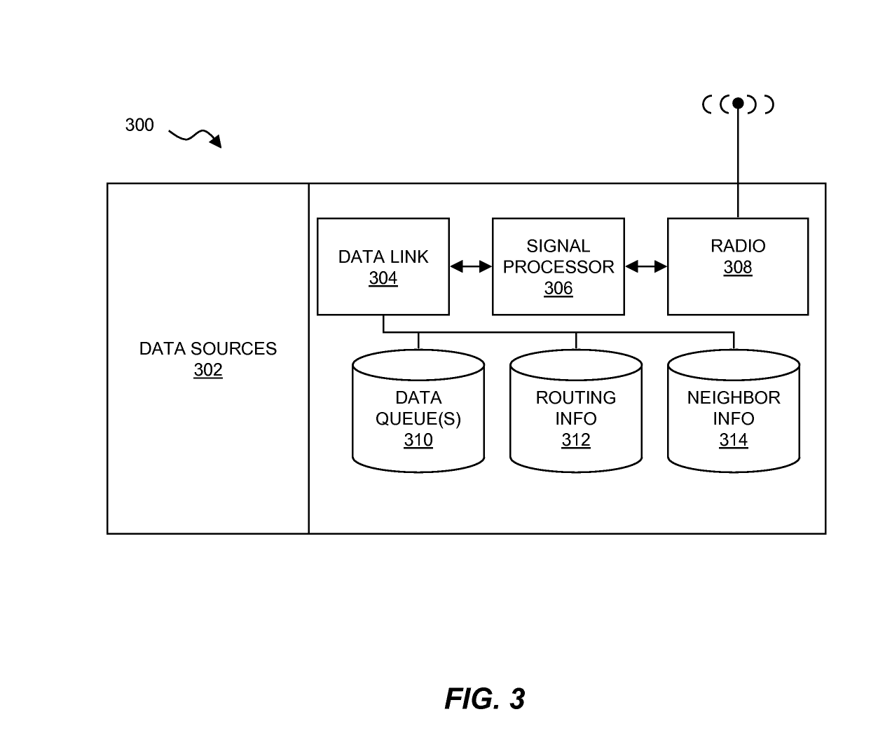

FIG. 3 is a block diagram of a node in a wireless ad hoc network such as the MANET described above. The node may be any of the devices described above, such as a subscriber device, access point, or backhaul access point. In general the node 300 may include data sources 302, a data link 304, a signal processor 306, a radio 308, data queues 310, routing information 312, and neighborhood information 314. It will be understood that the following description is general in nature, and that numerous arrangements of processing, storage, and radio frequency hardware may be suitably employed to similar affect. This description is intended to outline certain operations of a MANET node relevant to the systems and methods described herein, and in no way limits the invention to the specific architecture shown in FIG. 3.

The data sources 302 may include any applications or other hardware and/or software associated with the node 300. This may include, for example, programs running on a laptop or other portable computing device, a web server or client, a multimedia input and/or output sources such as a digital camera or video, and so forth. More generally any device, sensor, detector, or the like that might send or receive data may operate as a data source 302 in the node 300. It will be further understood that some nodes such as access points 104 may not have independent data sources 302, and may function exclusively as MANET 100 network elements that relay data among other nodes and/or provide network stability as generally described above.

The data link 304 may include hardware and/or software implementing data link layer functionality such as neighbor management, segmentation and reassembly of data packets, Quality of Service (QoS) management, data queue servicing, channel access, adaptive data rates, and any other suitable data link functions. In general, the data link 304 controls participation of the data sources 302, and more generally the node 300, in a MANET. It will be understood that the data link 304 in FIG. 3 may implement any number of lower layer (e.g., physical layer) or higher layer (e.g., routing, transport, session, presentation, application) protocols from a conventional Open Systems Interconnection (OSI) Model, or any such protocols and related functions may be implemented elsewhere within the node 300, such as in an IP stack executing on the data source 302, or in firmware within the signal processor 306 or radio 308, or in additional functional blocks not depicted in FIG. 3. For example, routing protocols may be implemented within hardware/software of the data link 304 in order to ensure that nodes in the MANET 100 share appropriate routing functions. Thus it will be appreciated that while the certain elements discussed herein might suitably be placed within the data link layer of a formal protocol stack, the systems and methods of this disclosure might also or instead be implemented with variations to a conventional protocol stack, or without any formal protocol stack whatsoever.

The data link 304 may include a link manager that collects neighbor information from the data link layer, and may form and maintain the neighborhood information 314 for the node 300. This table may be used to establish routes to neighbors, and may be updated periodically with information from one and two hop neighbors as described further below. The link manager may monitor statistics on all active links for a node on a link-by-link basis in order to support link quality calculations and other functions described herein. The term metadata is used herein to generally refer to the neighborhood information 314 for the node 300 or any other information characterized one or more nodes, data links, or other network characteristics that might be shared among nodes to describe the network in which nodes are participating and communicating. In general, the metadata includes at least one item of metadata, although any number of metadata items might be usefully employed according to the number of nodes in a neighborhood and the amount of information to be exchanged among nodes.

The signal processor 306 may include waveform processing and timing functions associated with transceiving data at the node 300. This may include, for example, network timing, time-slot and/or frame-based waveform configuration, maintenance of one or more families of Orthogonal Frequency Division Multiplexing waveform modes (or other transmit mode waveforms), receiver detection of waveform modes, error correction coding, and so forth. In general, the signal processor 306 may be implemented in any suitable combination of digital signal processors, field programmable gate arrays, application-specific integrated circuits, microprocessors, or other general or special-purpose computing devices. It will be understood that the signal processor 306 may be any processor described herein including a microprocessor, a microcontroller, a digital signal processor, an application-specific integrated circuit, a programmable-array logic device, a field programmable gate array, or any other device or combination of the foregoing that can process, or be programmed to process, digital and/or analog signals as described herein.

In one embodiment, a family of Orthogonal Frequency Division Multiplexing (OFDM) waveforms may be employed for adaptive data rate communications. The modes of the OFDM waveforms may, for example, include 7.2 MHz Quadrature Phase-Shift Keying (QPSK), 4.8 MHz QPSK, 2.4 MHz QPSK, 1.2 MHz QPSK, 1.2 MHz Binary Phase-Shift Keying (BPSK), or the like. The effective data rate for transmit waveforms may be affected by other parameters such as error correction. In order to facilitate implementation of an adaptive rate system, the transmit modes may be organized into an ordered list of monotonically increasing data rates matched to correspondingly decreasing signal robustness, thus permitting unique mapping of link quality to transmit mode. In one aspect, the actual waveform mode selected to transmit data on a link may be adaptively selected according to any suitable evaluation of link quality for links to neighboring nodes.

The radio 308 in general operates to transmit data from the data queue(s) 310, as organized and encoded by the data link 304 and the signal processor 306 (along with any control information, packet header information, and so forth), over a wireless air interface to other nodes in a MANET, and to perform complementary data reception. The radio 308 may include any radio frequency analog circuitry and the like, and may be coupled to the signal processor 306 which converts data and control information between a digital representation used within the node 300, and an analog representation used in radio frequency communications with other nodes. In embodiments, a low power radio 308 may be employed, such as where the node 300 is a battery-powered mobile device. In other embodiments, a high-power radio 308 may be employed, such as where the node 300 is an access point or backhaul access point connected to a fixed power infrastructure. In an embodiment, the radio 308 and signal processor 306 provide adaptive data rate coding capable of changing transmit modes, error correction, and the like according to measured link quality.

The data queue(s) 310 may include any data for transmission from the node 300. This may include, for example, data from the data sources 302, data that is relayed by the node 300 from other nodes in the MANET, and/or control information scheduled for transmission within data packets from the node 300. The data queue(s) 310 may be organized in any suitable fashion, and may include a single first-in-first-out queue, multiple queues, prioritized queues, and the like. In one embodiment, the node 300 may include multiple prioritized queues to assist in providing various service levels, such as for QoS traffic. In general, data in the data queue(s) 310 is delivered according to any suitable queuing mechanism to the data link 304, signal processor 306, and radio 308 for transmission within the MANET.

Routing information 312 such as a routing or forwarding table may be provided to support routing functions by the node 300. In general, this may include, for example, a destination address or identifier, a cost of a path to the destination (using any suitably cost calculation), and a next hop on that path. Other information such as quality of service and other metrics for various routes and links may also be provided for more refined routing decisions.

Neighborhood information 314 may be maintained in a database, flat file, routing table, or other suitably organized volatile or non-volatile storage within the node 300. The neighborhood information 314 generally supports the creation and maintenance of the MANET as well as routing functions of each MANET node. Within the MANET, each node may interact with other nodes to autonomously identify and maintain local network connections, shift capacity, dynamically form routes throughout the network, and so on. The routing functions of the node (as supported by the neighborhood information 314) may accommodate delay-sensitive (e.g. voice) traffic, delay-tolerant traffic with quality of service (QoS) prioritization, and so on.

The neighborhood information 314 may include an identification of neighboring nodes along with information relating to those nodes. This may include one-hop neighbors (i.e., neighboring nodes in direct wireless communication with the node 300), two-hop neighbors (i.e., neighboring nodes that communicate with the node 300 through only one other node), or any other nodes or participants within the MANET. In one aspect, neighborhood information 314 includes link quality information for the radio 308, which may be obtained from any combination of physical layer and data link data, and may be employed to adapt the data rate of communications according to currently present channel conditions. The neighborhood information may also include QoS data used to select next hops for QoS data. Other useful information may include bandwidth utilization, node weights, node position (either logical or physical), and queue latency for each QoS type and/or other priority type.

In one aspect, the neighborhood information 314 may be gathered during periodic exchanges (such as during control transmissions) with neighboring nodes, which may occur under control of the link manager of the data link 304. For example, the node 300 may determine output bandwidth (i.e., data transmit requirements) for each link that the node 300 has with a neighbor, and may transmit this to one-hop neighbors. Similarly, the node 300 may receive output bandwidth from each one-hop neighbor. Using this data, each node 300 may further calculate its own input bandwidth (i.e., data receive requirements) from each link to a neighboring node, and this information may in turn be exchanged with one-hop neighbors. Following a system-wide exchange with one-hop neighbors, the node 300 (and every other node in the MANET) may calculate a node weight that represents relative output requirements for the node 300. For example, the node weight, W, may be calculated as:

$$W = \frac{{BW}_{out}}{{BW}_{out } + {BW}_{i n}} \qquad [ Eq . 1 ]$$

where BWₒᵤₜ is the total output or transmit requirements for each link of the node 300, and BWᵢₙ is the total input or receive requirements for each link of the node 300. Finally, the node 300 may transmit the node weight to each neighboring node, and may in turn receive a node weight from each neighboring node. It will be appreciated that the node weight, W, may be further processed for use with other neighborhood information 314, such as by limiting the value according to the number of bits used for control information, or by providing a supplemental adjustment to the node weight to further refine control of routing or other MANET functions. Sharing of information for maintenance of the neighborhood information 314 may be controlled, for example, by the data link 304, which may apply any suitable technique to determine when to share information with one hop neighbors. In one aspect, the data link 304 may transmit data whenever a change is detected in the MANET such as an addition or deletion of a node.

As noted above, any of the neighborhood information 314, routing information 312, and/or data queue(s) 310, as well as status or other information concerning any of the foregoing, may usefully be shared among the nodes participating in a network, and all such information is intended to fall within the meaning of metadata as that term is used herein.

In another aspect, for a MANET that has location-aware nodes 300 (e.g., using Global Positioning System (GPS) data, signal strength data, and so forth), the neighborhood information 314 may include position data in order to support location-based routing and the like.

Having described a MANET in general terms, the description now turns to a more detailed treatment of mobile nodes.

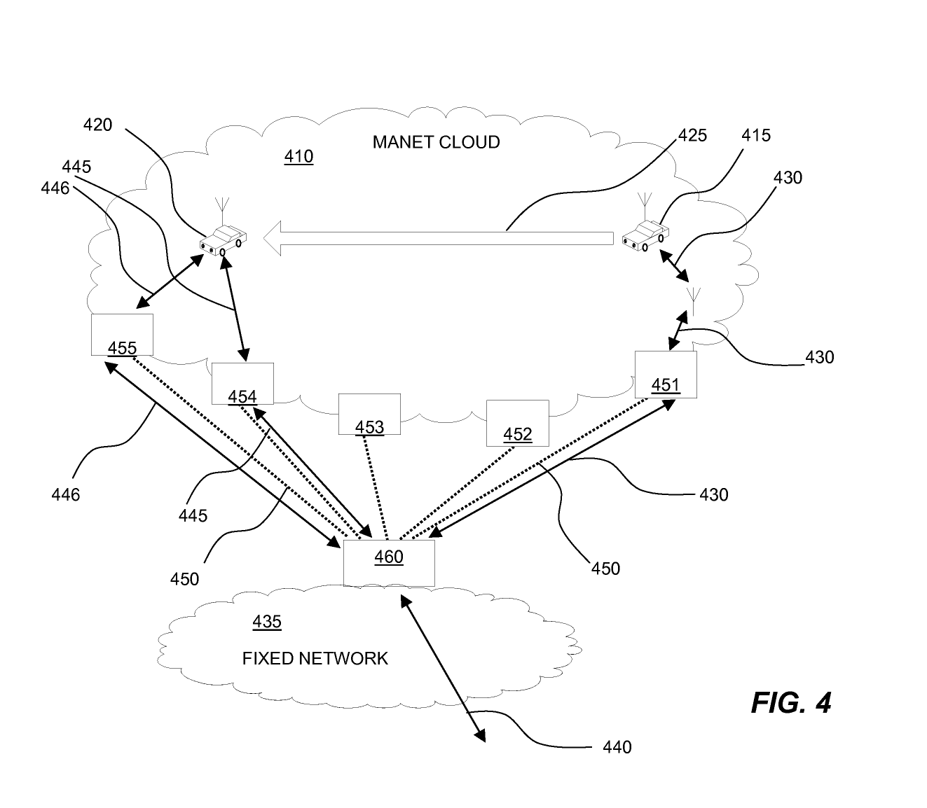

FIG. 4 shows vehicular mobility traffic within a wireless ad hoc network, that is, network traffic to or from a highly mobile or quickly moving node. In general, a vehicle 415 may move at a relatively high speed (e.g. 60 miles per hour or more) through a MANET cloud 410. As a result, a MANET device within the vehicle may rapidly switch its spatial relationship to other nodes in the MANET cloud, and may experience rapid changes in the distance to the nearest Backhaul Access Points (BAP) and may even change locations sufficiently to result in a different BAP being closest. This movement is generally depicted in FIG. 4 by arrow 425 that indicates motion from right to left. It will be understood that, while an automobile is depicted in FIG. 4, the vehicle 415 may be any vehicle capable of relatively rapid movement such as a motor-cycle, bicycle, helicopter, motorboat, or other vehicle, or more generally any MANET-enabled wireless device that moves rapidly, is expected to move rapidly, or is known to have a capability to move rapidly.

As shown in FIG. 4, vehicle 415 may move to a new location 420. In general the vehicle may remain within a MANET 410. The MANET 410 communicates through BAPs 451-455 and backhaul links 450 to an edge router 460. The edge router 460 may communicate with a fixed network 435 and provide traffic 440 to and from a network such as the internet. At one point in time, traffic 430 from a vehicle 415 at an initial point flows through BAP 451. After a period of time vehicle 415 may move to location 420. A motion vector 425 may be calculated which determines expected locations for the vehicle after the move. By calculating the motion vector and knowing an initial location, data may be sent to the location where the vehicle is expected. The vehicle may be near its original location or it may have moved a significant distance. If the vehicle is near its original location then many of the communication routing portions may be similar to the original routing. If the vehicle has moved a significant distance then the expected routing may be vastly different from the original path. A new location 420 may be anticipated based a motion vector 425. The new location 420 may be an expected range of locations based on the motion vector. The range of locations may be based on knowledge of vehicular congestion, acceleration, and other factors. Traffic may be sent to multiple BAPs such as 454 and 455, by way of example. Data may be sent on multiple routes such as a route 445 through BAP 454 and a route 446 through BAP 455. Whichever BAP is closer may communicate the data to the vehicle in new location 420. The MANET may determine a node or backhaul access point within a one-hope neighborhood of the location. The node that is within the one hop neighborhood of location 420 may communicate the data. Data that arrived at other locations may be deleted or removed from the network.

In this vehicular mobility environment, a number of constraints may be applied at a vehicular node to achieve optimization of routing to/from vehicular nodes. First, vehicular mobile nodes may be prohibited or discouraged from participating in relay of traffic to or from stationary or lower speed nodes. This may involve having the node restricted from relaying data as part of the scoped multicasting. This prohibition may reduce the ripple in MANET topology caused by a fast moving node. Second, vehicular mobile nodes may preferentially communicate with a specific backhaul access point as long as power requirements are met (e.g. where high power not required for transmit). Third, vehicular mobile nodes may hand off to an overlaid cellular network where only high-power transmission alternatives are available within the MANET cloud. Fourth, vehicular mobile nodes may attempt communication by the node with a second mobile node with a similar motion vector. The communication may include relaying data through the second mobile node since the other vehicular mobile node may be travelling in the same direction and towards an access point.

A number of constraints may also, or instead, be applied at an edge router and/or backhaul access points. In one aspect, an edge router may calculate a motion vector for the mobile node (including, e.g. speed and direction) using Global Position System (GPS) data, Time Difference of Arrival (TDOA), or any other suitable location technology or combination of technologies. Using the vector data, the edge router may anticipate a scoped region, such as is shown in FIG. 4, where the mobile node will be for return traffic. The edge router can accordingly send scoped multicast traffic to a vehicular node in an area where the vehicular node is expected to be. Similarly, nodes that discover the vehicular node may relay this traffic to the vehicular node. Access Points may operate similarly when discovering a vehicular node in their region or domain.

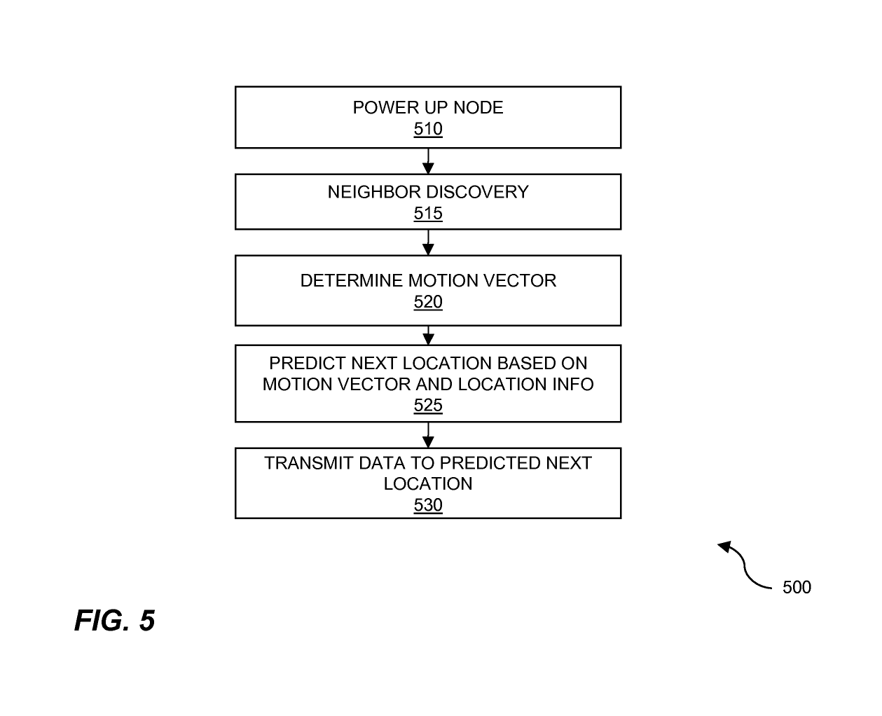

FIG. 5 shows a flowchart for a method 500 of transmitting to anticipated locations. It should be noted that the various blocks or steps within flow 500 are illustrative. The exact order may vary and certain steps may be repeated or omitted.

As shown in step 510, a node may enter a MANET, such as upon power up or boot up, or when the node moves within the geographic area of a MANET or a BAP domain thereof. At the time of network entry, the node may have no knowledge about its neighborhood, about a routing path to a BAP, or about previous operations. Similarly, step 510 may represent when a mobile node moves from one BAP domain to another. The lack of knowledge is similar to that of power up and the need for information and the following steps may be similar.

As shown in step 515, the node may proceed to discovering its neighbors, information about its neighbors, and information about the neighborhood in general. One or more neighbor nodes to the node may be discovered. The discovery of information may include identifying a node within the wireless ad hoc network where the node is a mobile node and the node is moving above a certain rate of speed. The discovered information may include the neighbor node's route cost to its serving BAP. The discovered information may include mobility of the node or neighbors of the node. The node may add information discovered about its neighbors to a neighbor table. The mobility information may be sent to a BAP. The mobility information may also be sent to an edge router and be retained elsewhere in the MANET and network. The current location of the node may likewise be sent to the BAP, edge router, or other locations within the network as deemed useful.

As shown in step 520, the process may include determining a motion vector for the node. The current location may be known or determined at this point. The motion vector may include information on the current speed in two or three dimensions. Information about current acceleration or deceleration of the node may also be calculated. Further, information about possible changes in speed, due to typical or current vehicular traffic congestion or other changes in motion may be evaluated. The current location and motion vector may be determined using GPS, cellular or other signal triangulation, TDOA, and other techniques. Geo location information may be used and obtained to aid in determining the motion vector. Overall motion may be considered. For example, if an overall motion is known to be circular or some arc then prediction and the motion vector may be different than if a simple straight line estimation of a motion were used. The radius of an arc or a circle may be used to calculate a curved motion vector.

As shown in step 525, the process may include calculating route prediction estimates based on location data and the motion vector for the node. A prediction of the next location of the mobile node may be made. The prediction may be based on the last location of the node and the motion vector which was determined. The prediction may be specific or it may provide a range of possible locations that the mobile node will be at a specific point in time. The next location may be near the original location or it may be a significant distance from the original location. The next location may be in a different BAP domain or may be near a plurality of different BAP domains. Where roadway or other vehicular paths or the like are known (either through explicit mapping or through analysis of historical data for nodes), location predictions may be based on corresponding assumptions about vehicular travel. Still further, actual vehicle traffic patterns (e.g., congestion, intersections, toll booths, roadway accidents, etc.) may be analyzed to assist in predicting changes in speed as well as direction, with data coming from observations of other MANET nodes, cellular devices, and the like, or with data coming from third party information providers such as traffic reporting services.

As shown in step 530, the process may include performing scoped multicasting to transmit data to locations where the node is expected to be based on the route prediction estimates which were calculated. The data may be transmitted to the next predicted location. The data may also be transmitted to multiple locations based on the motion vector, using scoped multicasting. The scoped multicasting may be described as sending data to multiple locations in anticipation of the node being at those locations as opposed to waiting for a route determination to be performed once the node reaches the next transmission location.

BAP domains provide a useful overlay for large MANETs that may be usefully combined with vehicular mobility as described herein. BAP domains are used to segment nodes of a MANET into groups or clusters each of which is associated with a particular backhaul access point. This greatly simplifies routing and similar network operations by numerically restricting the number of nodes in a MANET and imposing finite limits on route cost calculations and the like. In general, membership in a segment or domain of a MANET may be resolved through any of a variety of techniques generally unrelated to the management of traffic from highly mobile nodes as described herein, and all such techniques that can be adapted to support BAP domains are intended to fall within the scope of this disclosure. Regardless of how determined, each node may be associated with a specific BAP domain (and a corresponding backhaul access point). Where motion vectors can be used to predict a nearest or otherwise most preferred BAP domain (e.g., based on traffic congestion, current domain size, etc.) for an expected, future location, the MANET may proactively prepare for the domain change in any of a number of ways. In general, this may include forwarding traffic to the node from an edge router to the predicted BAP domain, attempting to send traffic from the node to the BAP domain. This may also include preparatory operations for the node to join the BAP domain such as forwarding node data or the like through the backhaul to the predicted domain.

The next predicted location of a node may result in transmission from the node to a different BAP domain. Predicted routing may be determined based on the expected next location. In some aspects, the process may include estimating that the node will move to a different backhaul access point domain based on the motion vector. The process may then include transmitting to the different backhaul access point domain. Routing paths may be used to send copies of the data to multiple locations (or domains). The data may be transmitted to the multiple location nodes based on the motion vector even though only one of those locations actually needs to send the data to the mobile node. A node within a one hop neighborhood may communicate the data at the next location to the mobile node. The unused copy or copies of the data which was transmitted may be deleted. This data from one of the multiple location nodes may be discarded since the one of the multiple location nodes may be found to not be a one hop neighbor of the node. Once the new location is known, the estimated location routing to the new location may be used or a cost based routing calculation may be performed. The new location may be used in a next motion vector calculation. Likewise the original location and the new location may be used as part of the next motion vector calculation, or update, for determining future possible locations to transmit future data.

In one aspect, an access point such as a backhaul access point may identify mobile nodes and predict locations for the mobile nodes based upon motion vector data obtained using any suitable location technology. In another aspect, an access point such as a backhaul access point may use scoped multicasting to transmit data to all possible locations (e.g. backhaul access point regions or domains) where the mobile node might be based upon the motion vector data. In another aspect, highly mobile nodes may be identified and discriminated, such as by excluding them from routing calculations, in order to mitigate adverse impact such as route ripple.

Having described the treatment of mobile nodes, the description now turns to a more detailed treatment of BAP domain techniques.

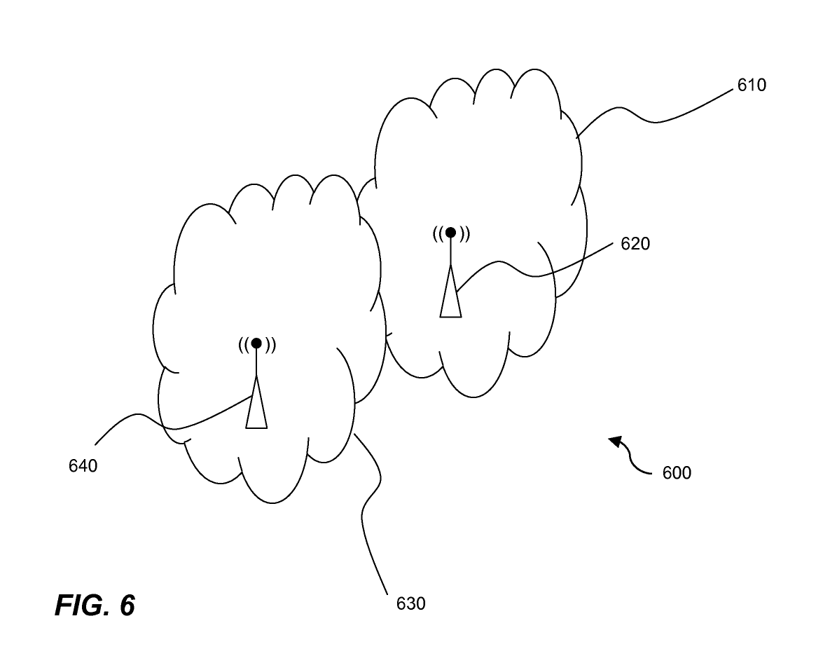

FIG. 6 shows a MANET 600 containing two MANET BAP domains. In general, an arbitrary MANET cloud or BAP domain 610 may be formed around a Backhaul Access Point (BAP) 620 that connects the MANET 600 to another network such as the Internet. A second arbitrary MANET cloud or BAP domain 630 is shown containing another BAP 640. As shown in FIG. 6, MANET BAP domains 610, 630 may intersect each other and BAPs do not need to be at the center of corresponding BAP domains. In general, participation in a BAP domain is explicitly determined by each node, with membership information stored and optionally updated from time to time such as when the node is mobile.

A variety of techniques may be employed to determine membership in a BAP domain, as well as when to switch from one BAP domain to another, as discussed in greater detail below. For example, through neighbor discovery, the various mobile nodes, fixed nodes, access points etc. within a MANET may identify their neighbors and in turn identify paths to the Internet or other fixed network structure(s) through BAPs, with nodes forming a BAP domain around each BAP. Although certain nodes might potentially belong to two or more BAPs based upon network coverage, limiting inter-nodal communication to nodes within a BAP domain can provide a useful abstraction for confining network operations such as routing, multicasting, and so forth to a relatively small and well-defined (or at least, better defined) group of nodes. In certain embodiments, a node might also or instead usefully belong to two or more BAPs although certain features described below are expressly limited to environments where each node exclusively belongs to a single BAP domain. A BAP domain may generally be created around a BAP whenever a BAP is powered up, and various nodes around the BAP may either join the new BAP domain or remain in an existing BAP domain (if any) using any suitable allocation scheme or algorithm. Through communications within a BAP domain, the various nodes within the BAP domain update the BAP domain as needed. For instance, a mobile node may move into a BAP domain region. As information is exchanged with the mobile node, the BAP domain may add the mobile node to the domain. The mobile node may then communicate with the Internet through the BAP associated with the BAP domain, and may engage in communications with other nodes within the BAP domain. Similarly, other characteristics of the BAP domain may be updated through the exchange of information between the various nodes which comprise the BAP domain.

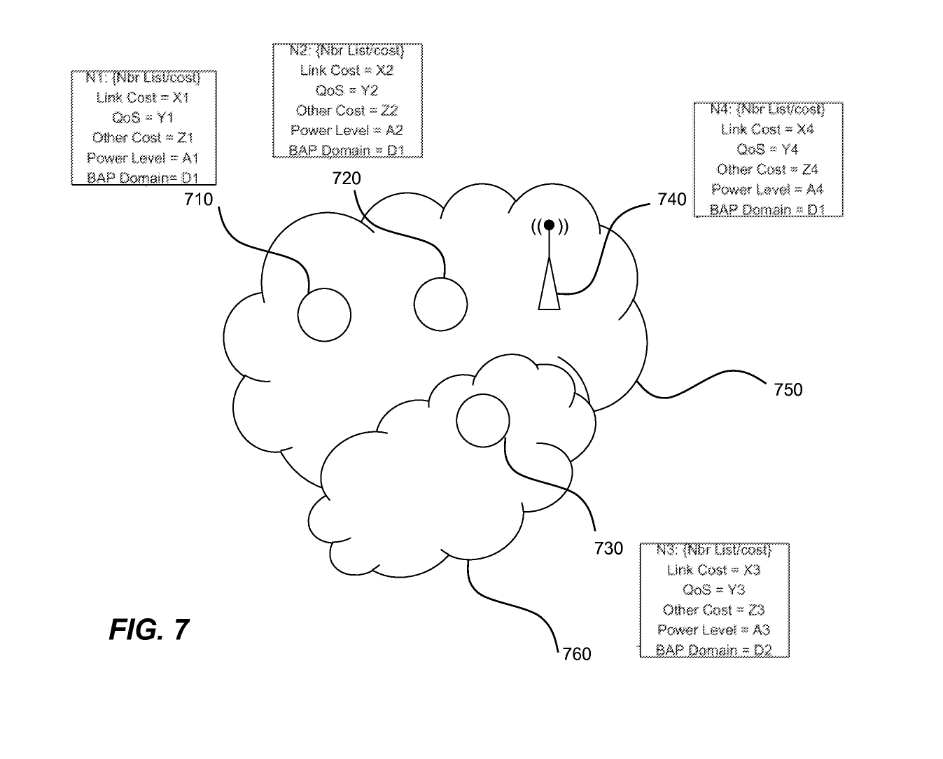

FIG. 7 illustrates information maintained by nodes in a MANET protocol. More specifically, FIG. 7 shows three mobile nodes N1 (710), N2 (720), and N3 (730) and a BAP N4 (740) in a first BAP domain 750. Mobile node N3 (730) belongs to an overlapping BAP domain 760 and co-exists with other nodes N1 (710) and N2 (720). All of these nodes may advertise their link state, per suitable MANET protocols, along with additional information such as link cost, QoS, power level and BAP domains. Mobile nodes may use this information to create different topologies based on different criteria. For example, even between a single sending node and a single receiving node (or multiple nodes in a multicast context) one routing tree, path or the like may be optimized for QoS delivery, while another, different routing tree, path, or the like may be optimized for power consumption. Similarly, the members of a BAP domain may vary according to the criteria used for inclusion.

Mobile nodes may advertise a variety of properties, which may be exchanged among nodes either within or on top of a MANET routing or datalink protocol.
1. Link Cost (as provisioned)
2. Link Cost (as discovered)
3. Route Cost (as provisioned)
4. Route Cost (as discovered)
5. Node Cost (as provisioned)
6. Node Cost (as discovered)
7. QoS (as provisioned)
8. QoS (as discovered)
9. Power usage
10. Hops (cost) to BAP
11. Mobility (vehicular, pedestrian node or fixed)
12. Motion vector information

In one aspect, a network layer in a MANET domain may be used to coordinate a broadcast of router control information within the domain. Router control information may usefully include:
1. Link Cost—any measure of cost for using a particular link
2. Route Cost—any measure of using a route (including number of links, or any sum or other measurement of link costs within a route)
3. Power Cost—any measure of power usage for a route and/or links
4. CPU Cost—any measure of processing required for a route and/or links
5. Configurable Cost—any measure of creating or changing a route or nodes within the route
6. Adaptive data rate (ADR) information—any measure of data rates and/or transmission modes for links of a node or a route

This information may be gathered and maintained within a routing protocol (such as within a network layer) and broadcast at any suitable interval according to the protocol and/or related protocols of a MANET. Each receiving node for the control information may create different routes to a destination based on the various criteria such as power, link cost, etc. Once a MANET routing protocol converges with this additional information, all nodes may have different routing topologies based on these criteria.

This additional router control information may be exploited by tagging network traffic to identify or determine which criteria to use for routing the traffic. For example, all host traffic may be tagged and assigned a set of QoS values based on programmable application awareness logic. This application awareness logic may, for example, determine traffic requirements for a given data flow, e.g. VoIP (or other voice data), an MP3 download (or other audio data download), streaming video, etc. Once traffic is tagged appropriately, relay nodes may use this information, along with the router control information, to route the traffic. For example, relay nodes may decide to route based on power utilization, instead of link cost, to save battery power.

Thus, improved routing of traffic to and from nodes moving at vehicular speeds has been described. In particular, highly mobile nodes may be identified based on location data, and route prediction information and motion vectors may be obtained. This data may be employed to improve communications, such as by using scoped multicasting to transmit data to locations where such nodes are expected to be, or by excluding such nodes from routing calculations for other nodes in a MANET.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the present invention are not limited to applications involving conventional computer programs or programmable apparatuses that run them. It is contemplated, for example, that embodiments of the presently claimed invention could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, Javascript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the present invention can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A method for wireless communication on a wireless ad hoc network, the method comprising:
identifying a node within the wireless ad hoc network where the node is a mobile node and the node is moving above a certain rate of speed;
determining a motion vector for the node;
calculating route prediction estimates based on location data and the motion vector for the node; and
performing scoped multicasting to transmit data to locations where the node is expected to be based on the route prediction estimates.

2. The method of claim 1 wherein the calculating route prediction estimates includes estimating that the node will move to a different backhaul access point domain based on the motion vector.

3. The method of claim 2 further comprising transmitting to the different backhaul access point domain.

4. The method of claim 1 wherein the node is restricted from relaying data as part of the scoped multicasting.

5. The method of claim 1 wherein the node preferentially communicates with a specific backhaul access point.

6. The method of claim 1 further comprising communicating between the node and a second mobile node with a similar motion vector.

7. The method of claim 6 wherein the communicating includes relaying the data through the second mobile node.

8. The method of claim 1 wherein the motion vector is determined using global positioning system (GPS) techniques.

9. The method of claim 1 wherein the data is transmitted to multiple location nodes based on the motion vector.

10. The method of claim 9 wherein the data at one of the multiple location nodes is discarded since the one of the multiple location nodes is found to not be a one hop neighbor of the node.

11. A computer readable medium bearing instructions for wireless communication that, when executed, cause a wireless ad hoc network to perform the steps of:
identifying a node within the wireless ad hoc network where the node is a mobile node and the node is moving above a certain rate of speed;
determining a motion vector for the node;
calculating route prediction estimates based on location data and the motion vector for the node; and
performing scoped multicasting to transmit data to locations where the node is expected to be based on the route prediction estimates.

12. The computer readable medium of claim 11 wherein the calculating route prediction estimates includes estimating that the node will move to a different backhaul access point domain based on the motion vector.

13. The computer readable medium of claim 12 that, when executed, further performs the step of transmitting to the different backhaul access point domain.

14. The computer readable medium of claim 11 wherein the node is restricted from relaying data as part of the scoped multicasting.

15. The computer readable medium of claim 11 wherein the node preferentially communicates with a specific backhaul access point.

16. The computer readable medium of claim 11 that, when executed, further performs the step of communicating between the node and a second mobile node with a similar motion vector.

17. The computer readable medium of claim 16 wherein the communicating includes relaying the data through the second mobile node.

18. The computer readable medium of claim 11 wherein the motion vector is determined using global positioning system (GPS) techniques.

19. The computer readable medium of claim 11 wherein the data is transmitted to multiple location nodes based on the motion vector.

20. The computer readable medium of claim 19 wherein the data at one of the multiple location nodes is discarded since the one of the multiple location nodes is found to not be a one hop neighbor of the node.
